(19) United States
(12) Patent Application Publication
(10) Pub. No.: US 2007/0159100 A1
(43) Pub. Date: Jul. 12, 2007

(54) Electrode for a high-pressure discharge lamp

(75) Inventors: Roland Huttinger, Kaufering (DE); Andreas Kloss, Neubiberg (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 10/583,915

(22) PCT Filed: Dec. 8, 2004
(86) PCT No.: PCT/DE04/02704

§ 371 Date: Jun. 21, 2006

(30) Foreign Application Priority Data
Dec. 22, 2003 (DE) 103 60 545.2

(51) Int. Cl. H01J 17/20; H01J 61/12; H01J 61/04

(52) U.S. Cl. 313/574; 313/631

(57) ABSTRACT

An electrode (35) for metal vapor-containing discharge lamps consists of a high-melting, electrically conductive material, preferably of tungsten or a material which predominantly contains tungsten; it comprises a shaft (36) having a pin-shaped head part (37), which defines a longitudinal axis L, at least one hole (39) being arranged essentially transversely with respect to the longitudinal axis, in particular at an angle of 60 to 90° with respect to the longitudinal axis, in the region of the head part (37).

### TECHNICAL FIELD

The invention is based on an electrode for a high-pressure discharge lamp having a metal vapor filling in accordance with the precharacterizing clause of claim 1. Of concern here are, in particular, electrodes for high-pressure discharge lamps which contain mercury and/or sodium, in particular sodium high-pressure lamps. A further application area is in metal halide lamps, for example. A further application area is in metal halide lamps without mercury.

### PRIOR ART

DE-C 976 223 has already disclosed an electrode for a high-pressure discharge lamp having a metal vapor filling, which uses a continuous hole. This hole is arranged essentially axially. It serves the purpose of stabilizing noble gas-containing high-pressure discharge lamps by it reducing the arc instability. With these lamps, which do not contain any metals which do not readily vaporize, such as mercury and sodium, but contain noble gases which are present in gaseous form, a capability to start immediately is characteristic. It is therefore not necessary to resort to any burn-in operations and starting-improving measures.

### SUMMARY OF THE INVENTION

It is the object of the present invention to provide an electrode in accordance with the precharacterizing clause of claim 1, in which the readiness of metal vapor-containing lamps to start is improved using simple measures.

This object is achieved by the characterizing features of claim 1. Particularly advantageous refinements are given in the dependent claims.

One further object is to provide a lamp having such an electrode and to specify a simple production method for such an electrode.

These tasks are achieved by the characterizing features of claims 15 and 16, respectively.

Electrodes for metal vapor-containing discharge lamps are generally equipped with filaments at the head part in order to improve starting. A known alternative to this is a spherical head or a cylindrical head. These measures are used for improving starting and arc transfer. However, it is complex to equip small electrodes with a filament or to provide them with a spherical head. The spherical head fuses and leads to undesirable structural changes. Both techniques require at least one additional method step.

It has surprisingly been found that one or more holes in the region of the head part of an electrode achieves the same effect. This provides the basis for a considerable simplification in electrode production; in particular it makes optimal shaping possible in the case of miniaturized electrodes for a low power rating in the range from 20 to 100 W. The electrode design is now particularly simple owing to the fact that a pin having a constant diameter can be used as the shaft with an integrated head part. Until now, this simplification has always failed owing to the fact that in this case the arc attachment migrates to and fro on the electrode and, in the case of lamps having a pinch seal at one end, even migrates to the pinch seal, which leads to destruction of the lamp.

The basic principle of the hole consists in the fact that a hollow-cathode effect is achieved by the holes providing a pre-ionization space for starting purposes. The volume of this space is preferably between 0.02 and 2 mm . When the lamp is started, this leads to a lower glow voltage, which ultimately results in two advantages. Firstly, the sputtering-off of the material of the electrode, generally tungsten on its own or at least predominantly tungsten as the main component of an alloy, is reduced. Finally, blackening is thus reduced and thus the lumen maintenance is improved. Secondly, a higher glow current is achieved. This leads to more rapid heating of the electrode. In particular if the two electrodes are equipped with such a hole, this leads to more rapid starting of the lamp. The transition from glow discharge to arc discharge is simplified.

A particularly desirable effect of the holes is the fact that they bring about a certain degree of thermal insulation of the tip. As a result, the electrodes heat up more rapidly, which accelerates starting of the lamp. In addition, there is little heat loss owing to thermal conduction during operation.

For an optimum result, a compromise therefore needs to be found between the requirement for pre-ionization and the requirement involving thermal insulation.

The base material used for producing the electrode may also be, inter alia, another high-melting metal apart from tungsten, namely tantalum, rhenium or an alloy or a carbide of these metals or else with a content of 50 to 20% by weight in addition to tungsten.

The electrode according to the invention can be used both in all ceramic discharge vessels and in glass discharge vessels for high-pressure discharge lamps. In this case, it is insignificant whether the discharge vessel is sealed at one or two ends. In the case of a pinch seal at one end, the electrode is bent back, in which case the hole is located in the bent-back head part. The electrode is held in the discharge vessel by means of its shaft, for example by means of a bushing which is part of the shaft or is attached thereto, this bushing being sealed off in a ceramic capillary, as is known per se, or in a pinch seal or fuse seal.

Simple manufacture of the electrode is possible if the hole is achieved mechanically or electrically. Particularly preferred is the production of the electrode using short laser pulses having a high energy density of at most 10 μs in duration, preferably of at most 2 μs in duration, the laser parameters being set such that no melting phase is produced, rather the tungsten is sublimed directly from the hole. A typical diameter for a hole is 200 μm; a typical diameter for the pin is 0.5 to 5 mm, depending on the wattage, which is typically 20 to 400 W, particularly advantageously for low wattages in the range from 20 to 75 W.

At least one hole is arranged essentially transversely with respect to the longitudinal axis, in particular at an angle of 60 to 90° with respect to the longitudinal axis, in the region of the head part. One to three holes are preferably used.

The shaft and the head part can advantageously have a uniform, predetermined diameter D for the pin. However, the diameter of the head part is critical and under certain circumstances can be greater than that of the shaft, with the result that the head part has a diameter D2 which extends beyond that of the shaft (diameter D1).

The hole may be continuous or in the form of a blind hole.

The head part should preferably contain at most three holes, which in particular are distributed evenly around the circumference of the head part.

In order to explain the preferred dimensions, it is established that the hole has a maximum diameter B. This need not be exactly constant.

The maximum diameter is often approximately the same in the case of a plurality of holes. In addition, the holes are preferably linear, but they may also be curved. In order to optimize the heat balance, holes with different diameters or a hole with a variable diameter are possible.

In the case of a plurality of holes, these holes may advantageously lie essentially in one plane. This has the advantage that the plurality of holes can be connected to one another such that the effect as the ionization space can be improved. If the hole is in the form of a blind hole, the blind holes should preferably have a depth of at least 50% of D, at most 80%.

In the case of a single pin, which offers particular advantages owing to the lack of further machining, it is recommended that the tip of the head part is rounded off. This can be achieved in the simplest case by tumbling of the pins. Sputtering-off of burrs and edges is thus prevented, which further improves the life, in interaction with the hole, in particular in the case of low wattages of 20 to 150 W.

If the distance between the hole (center of the hole) and the tip of the electrode is denoted by A, the ratio A/D should advantageously be in the range between 1 and 6 (end values inclusive). A hole which is particularly effective is one in which the ratio between the diameter B of the hole and the diameter D of the head part is between 0.05 and 0.3 (end values inclusive).

A typical lamp having at least one electrode having a hole has at least one discharge vessel which contains metal vapor, in particular mercury and/or sodium, the discharge vessel being produced from glass or ceramic. Of particular concern is relatively low-wattage lamps having a power rating of at most 400 W.

The preferred production method for producing an electrode from tungsten, in which the electrode has a pin-shaped head part having a longitudinal axis, is based on the fact that a hole is produced essentially transversely with respect to the longitudinal axis by short laser pulses of a maximum of 10 μs in duration. A pulsed neodym YAG laser is used as the laser. Its energy is focused such that it is above the energy density required for sublimation of tungsten. The rate of repetition is above 1 kHz.

### BRIEF DESCRIPTION OF THE DRAWINGS

The invention will be explained in more detail below with reference to a plurality of exemplary embodiments. In the drawings:

FIG. 1 shows a side view of a high-pressure discharge lamp;

FIG. 2 shows a section through a further high-pressure discharge lamp;

FIG. 3 shows a section through an electrode for the lamp shown in FIG. 1;

FIGS. 4 to 11 show further exemplary embodiments of electrodes.

### PREFERRED EMBODIMENT OF THE INVENTION

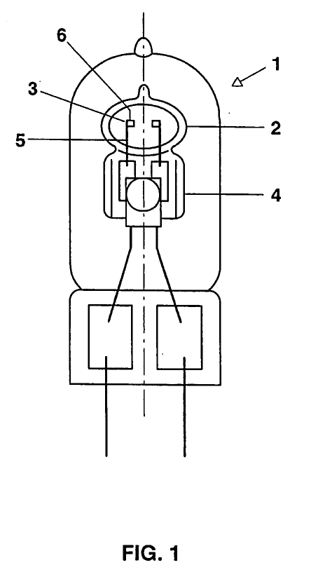

FIG. 1 shows a metal halide lamp 1 having a power rating of 35 W and having a discharge vessel 2 which is made from quartz glass and is sealed at one end. The electrodes 3 are sealed off by means of a pinch seal 4, the electrodes 3 being produced from W and having a shaft 5 in the interior of the discharge vessel, a cylindrical head 6 being attached laterally to said shaft 5. The discharge is formed between these tips. The cylindrical head 6 is provided with a hole which lies transversely with respect to the longitudinal axis of the head, see also FIG. 11. In particular, it is also sufficient if the electrode 3 is produced predominantly, i.e. more than 50%, from W, and the remainder may be, for example, rhenium. The filling contains mercury and halides of sodium, Sn, Tl, Tm, etc. The filling may also predominantly only contain mercury or sodium vapor. The precise filling is not critical.

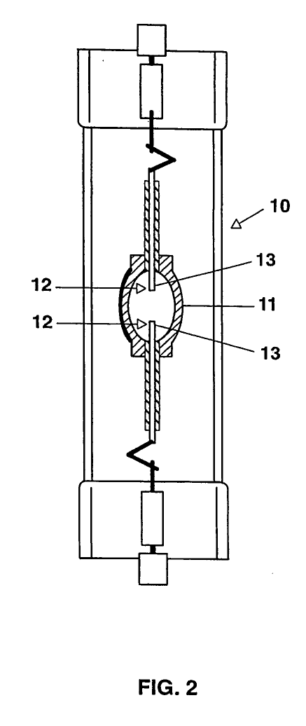

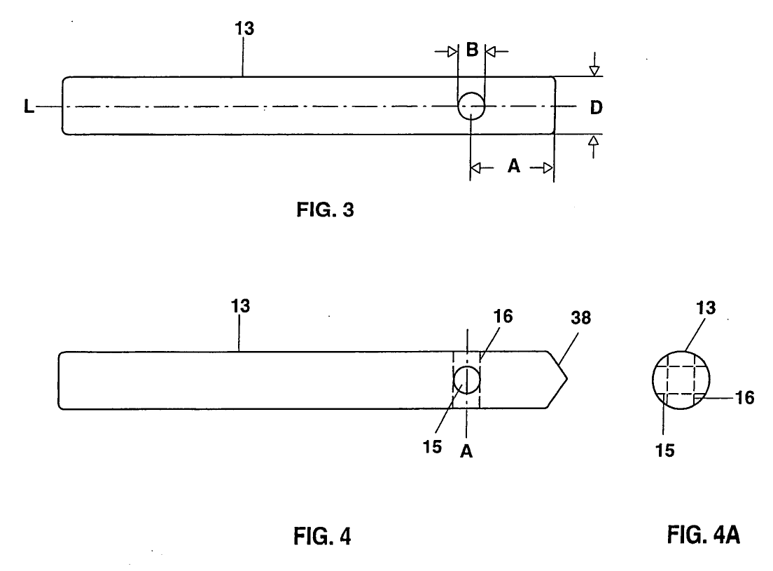

FIG. 2 shows a metal halide lamp 10 having a ceramic discharge vessel 11 which is sealed at two ends and has a power of 150 W. The electrodes 12 comprise pins 13, which have a constant diameter throughout. This diameter is 300 μm. At a distance of 2 mm from the tip, a hole is fitted transversely with respect to the longitudinal axis of the electrode, which hole has a diameter of 150 μm, see FIG. 3.

FIG. 3 shows an electrode for the lamp shown in FIG. 2, in detail. It has a continuous pin 13 having a diameter D. A hole 14 is fitted transversely with respect to the longitudinal axis L at distance A from the tip of the pin. It rests centrally in relation to the transverse axis and has a diameter B. Preferred dimensions are ratios of B/D of 0.05 to 0.30. Preferred ratios of A/D are 1 to 6.

FIG. 4 shows an electrode 13 having two holes 15, 16, which are offset through 90° with respect to one another in a plane transverse to the longitudinal axis L. Both holes are continuous, with the result that they are connected to one another at the center point, see FIG. 4A. The electrode 13 is tapered at its head 38.

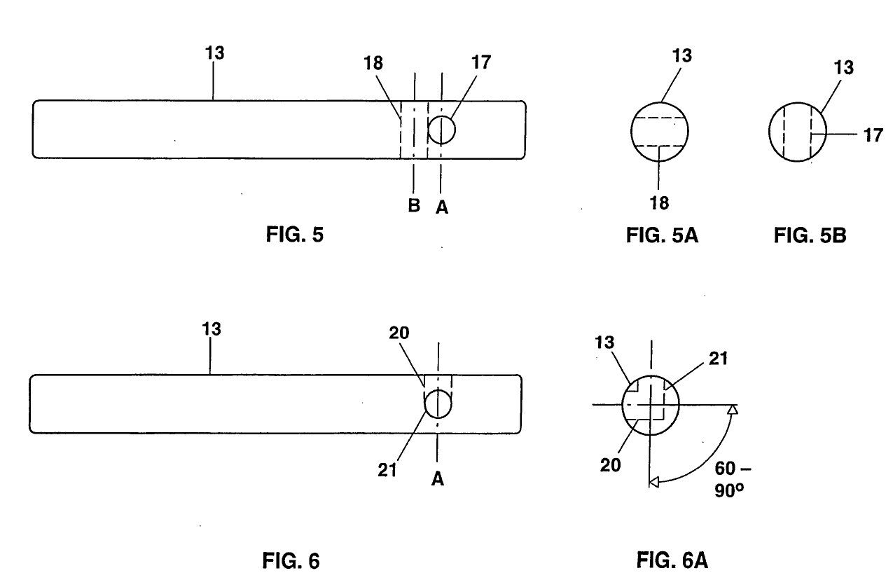

FIG. 5 shows an electrode 13 having two holes 17, 18, which are arranged offset through 90° with respect to one another in different planes. The two holes are continuous and have the same diameter, see FIGS. 5A and 5B.

FIG. 6 shows an electrode 13 having two holes 20, 21, which are offset through 90° with respect to one another in a plane transverse to the longitudinal axis L. The two holes are in the form of blind holes but are connected to one another at the center point, see FIG. 6A.

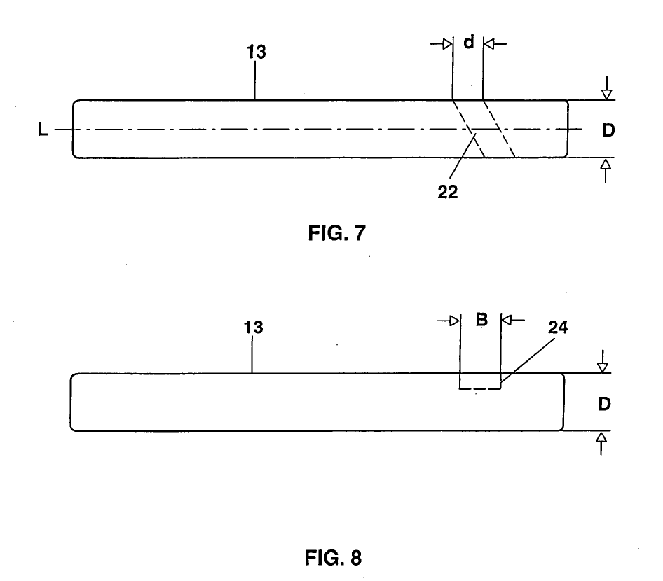

FIG. 7 shows an electrode 13 having a hole 22, which is inclined through 25° toward the longitudinal axis L. This version can be used in particular for horizontal mounting positions of the lamp.

FIG. 8 shows an electrode 13 having a short blind hole 24, which advantageously has at least 50%, preferably approximately 65%, of the depth of the diameter D. In this case, the diameter B needs to be selected to be relatively large for this in order to be able to provide sufficient pre-ionization space. B, in particular, should be selected to be in the range 0.8 D≦B≦1.2 D.

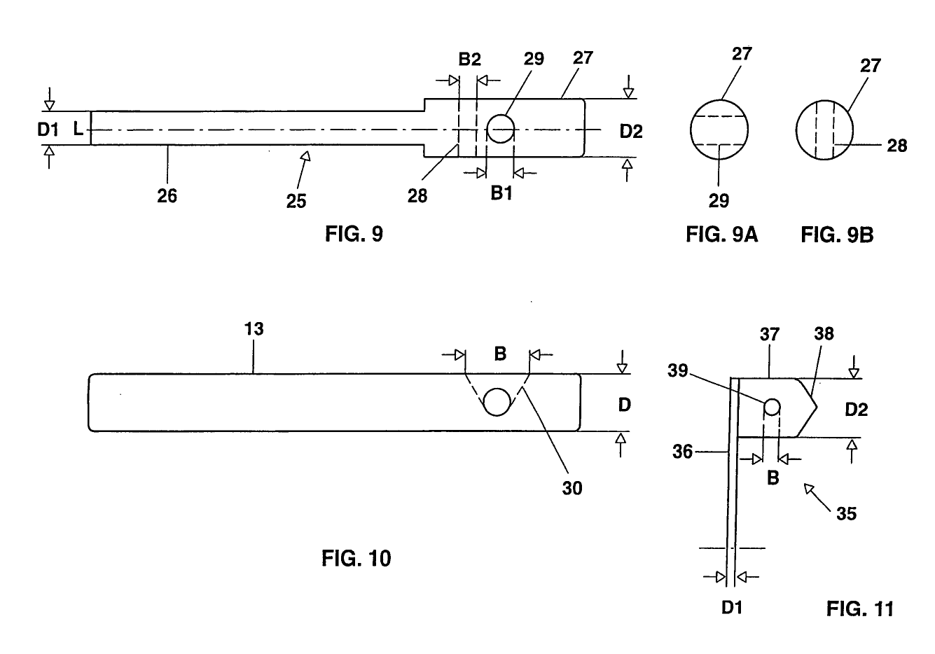

FIG. 9 shows an electrode 25 having a relatively large diameter Dl of the shaft 26, the head part 27 having a greater diameter D2 and, in particular, being attached separately. Such electrodes are recommended for relatively high power ratings of 150 to 400 W. The head part 27 has two holes 28 and 29, which are arranged offset through 90° with respect to one another in different planes transverse to the longitudinal axis L. The two holes are continuous, but have different diameters B1 and B2, see FIGS. 9A and 9B.

FIG. 10 shows an electrode 13 having a short blind hole 30, which has approximately 55% of the depth of the diameter D. In this case, the diameter B of the blind hole decreases from the outside inward, which is advantageous from a manufacturing point of view.

FIG. 11 shows an electrode 35 for a discharge vessel which is sealed at one end, in this case the shaft 36 being positioned transversely with respect to the head 37. The cylindrical head part has a tip 38 and a hole 39. Its diameter B should be selected to be relatively small compared with the diameter D2 of the head part, since in this case it is only used to make it possible to provide sufficient pre-ionization space. The high thermal capacity is already ensured by the large diameter D2 of the head part in relation to the diameter of the shaft D1.

The production of such electrodes takes place using short laser pulses of, for example, 5 μs in duration, often even shorter. The laser beam is in particular focused by means of lenses. It is preferably pulsed with a high rate of repetition of, for example, 3 kHz or more. The focusing should preferably take place such that the energy density of the focused laser beam is above the energy density required for sublimation of the material of the electrode.

1. An electrode (35) for metal vapor-containing discharge lamps made from a high-melting, electrically conductive material, preferably from tungsten or a predominantly tungsten-containing material, comprising a shaft (36) and a pin-shaped head part (37), which defines a longitudinal axis L, characterized in that at least one hole (39) is arranged essentially transversely with respect to the longitudinal axis, in particular at an angle of 60 to 90° with respect to the longitudinal axis, in the region of the head part (37).

2. The electrode as claimed in claim 1, characterized in that the shaft and the head part have a uniform, predetermined diameter D for the pin.

3. The electrode as claimed in claim 1, characterized in that the head part has a diameter D2 which extends beyond that of the shaft.

4. The electrode as claimed in claim 1, characterized in that the hole is continuous or is in the form of a blind hole.

5. The electrode as claimed in claim 1, characterized in that the head part contains at most three holes.

6. The electrode as claimed in claim 1, characterized in that the diameter of the hole varies, the hole having a maximum diameter B.

7. The electrode as claimed in claim 6, characterized in that the maximum diameter is in each case approximately the same size in the case of a plurality of holes.

8. The electrode as claimed in claim 1, characterized in that the hole is linear.

9. The electrode as claimed in claim 1, characterized in that the plurality of holes lie in one plane.

10. The electrode as claimed in claim 9, characterized in that the plurality of holes are connected to one another.

11. The electrode as claimed in claim 4, characterized in that each blind hole has a depth of at least 50% of D.

12. The electrode as claimed in claim 1, characterized in that the tip (7) of the head part is rounded off.

13. The electrode as claimed in claim 1, characterized in that the distance between the hole (center of the hole) and the tip is denoted by A, the ratio A/D being in the range between 1 and 6 (end values inclusive).

14. The electrode as claimed in claim 1, characterized in that the ratio between the diameter B of the hole and the diameter D of the head part is between 0.05 and 0.3 (end values inclusive).

15. A lamp having at least one electrode as claimed in claim 1, the lamp having a discharge vessel which contains metal vapor, in particular mercury and/or sodium, the discharge vessel being produced from glass or ceramic.

16. A method for producing an electrode, in which the electrode has a pin-shaped head part having a longitudinal axis, characterized in that a hole is produced essentially transversely with respect to the longitudinal axis by short laser pulses of a maximum of 10 μs in duration.

17. The method as claimed in claim 16, characterized in that the laser beam is focused.

18. The method as claimed in claim 16, characterized in that the rate of repetition of the pulses is at least 1 kHz.

19. The method as claimed in claim 17, characterized in that the energy density of the focused laser beam is above the energy density required for sublimation of the material of the electrode.
